(19) United States
(12) Patent Application Publication
(10) Pub. No.: US 2025/0180870 A1
(43) Pub. Date: Jun. 5, 2025

(54) OPTICAL IMAGING SYSTEM

(71) Applicant: Samsung Electro-Mechanics Co., Ltd., Suwon-si (KR)

(72) Inventors: Ju Hwa SON, Suwon-si (KR); Phil Ho JUNG, Suwon-si (KR); Yong Joo JO, Suwon-si (KR)

(73) Assignee: Samsung Electro-Mechanics Co., Ltd., Suwon-si (KR)

(21) Appl. No.: 18/758,143

(22) Filed: Jun. 28, 2024

(30) Foreign Application Priority Data
Nov. 30, 2023 (KR) 10-2023-0171739

(51) Int. Cl. G02B 13/00; G02B 9/64

(52) U.S. Cl. CPC G02B 13/0045; G02B 9/64

(57) ABSTRACT

An optical imaging system is provided. The optical imaging system includes a first lens, a second lens, a third lens, a fourth lens, a fifth lens, a sixth lens, a seventh lens, and an eighth lens, sequentially arranged from an object side toward an imaging plane, wherein the first lens has positive refractive power, and the second lens has negative refractive power, wherein the second lens and the third lens each have refractive indices that are greater than 1.66, and wherein the optical imaging system satisfies the following conditional expression:

$$TTL / ( 2 \times IMG HT ) < 0.64$$

where TTL is a distance on an optical axis from an object-side surface of the first lens to the imaging plane, and IMG HT is half a diagonal length of the imaging plane.

### CROSS-REFERENCE TO RELATED APPLICATIONS

This application claims the benefit under 35 USC § 119 (a) of Korean Patent Application No. 10-2023-0171739 filed on Nov. 30, 2023, in the Korean Intellectual Property Office, the entire disclosure of which is incorporated herein by reference for all purposes.

### BACKGROUND

### 1. Field

The following description relates to an optical imaging system.

### 2. Description of Related Art

Portable terminals are equipped with cameras including an optical imaging system comprised of a plurality of lenses to enable video calls and image capturing.

Furthermore, as the operation and implementation of cameras in portable terminals gradually increases, the demand for cameras for portable terminals, having high resolution, is growing.

Recently, image sensors with high pixels (e.g., 13 million to 100 million pixels) are being implemented in cameras for portable terminals in order to realize clearer image quality.

In other words, the size of image sensor has increased, and as a result, the total track length of the optical imaging system has increased, which may eventually cause the camera to protrude from the portable terminal.

As portable terminals are gradually becoming smaller, it is beneficial if the cameras for portable terminals have a slim form factor. Accordingly, the development of an optical imaging system that is slim yet achieves high resolution, is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical imaging system includes a first lens, a second lens, a third lens, a fourth lens, a fifth lens, a sixth lens, a seventh lens, and an eighth lens, sequentially arranged from an object side toward an imaging plane, wherein the first lens has positive refractive power, and the second lens has negative refractive power, wherein the second lens and the third lens each have refractive indices that are greater than 1.66, and wherein the optical imaging system satisfies the following conditional expression: TTL/(2×IMG HT)<0.64, where TTL is a distance on an optical axis from an object-side surface of the first lens to the imaging plane, and IMG HT is half a diagonal length of the imaging plane.

Each of at least three lenses among the first lens to the eighth lens, including the second lens and the third lens, may have a refractive index that is greater than 1.66, and an absolute value of a focal length of the second lens, among the at least three lenses having a refractive index greater than 1.66, is the smallest absolute value.

The fifth lens may have a refractive index that is greater than 1.66, and wherein the optical imaging system satisfies the following conditional expression: |v1−(v2+v3+v5)|<10, where v1 is an Abbe number of the first lens, v2 is an Abbe number of the second lens, v3 is an Abbe number of the third lens, and v5 is an Abbe number of the fifth lens.

The following conditional expressions may be satisfied: 25<v1-v2<45; and 25<v1-v3 <45, where v1 is an Abbe number of the first lens, v2 is an Abbe number of the second lens, and v3 is an Abbe number of the third lens.

The following conditional expression may be satisfied: 15<v1−(v2+v3)<25, where v1 is an Abbe number of the first lens, v2 is an Abbe number of the second lens, and v3 is an Abbe number of the third lens.

The following conditional expression may be satisfied: 1.3<Fno<1.6, where Fno is an F-number of the optical imaging system.

The following conditional expression may be satisfied: 0.9<f1/f<1.2, where f1 is a focal length of the first lens, and f is a total focal length of the optical imaging system.

The following conditional expression may be satisfied:-3<f2/f<−1, where f2 is a focal length of the second lens, and f is a total focal length of the optical imaging system.

The following conditional expression may be satisfied: |f3/f|>30, where f3 is a focal length of the third lens, and f is a total focal length of the optical imaging system.

The following conditional expression may be satisfied: 0.3<|f1/f2|<0.6, where f1 is a focal length of the first lens, and f2 is a focal length of the second lens.

The following conditional expression may be satisfied: |f1/f3|<0.05, where f1 is a focal length of the first lens, and f3 is a focal length of the third lens.

The following conditional expression may be satisfied: |f2/f3|<0.08, where f2 is a focal length of the second lens, and f3 is a focal length of the third lens.

The following conditional expression may be satisfied: 1.3<f12/f<1.7, where f12 is a composite focal length of the first lens and the second lens, and f is an overall focal length of the optical imaging system.

The following conditional expression may be satisfied: 1.3<f123/f<1.7, where f123 is a composite focal length of the first lens to the third lens.

The fourth lens may have positive refractive power, and the fifth lens may have negative refractive power.

The sixth lens may have positive refractive power, the seventh lens may have positive refractive power, and the eighth lens may have negative refractive power.

Other features and aspects will be apparent from the following detailed description, the drawings, and the claims.

### BRIEF DESCRIPTION OF DRAWINGS

FIG. 1 illustrates a configuration diagram of an example optical imaging system, in accordance with a first example embodiment.

FIG. 2 illustrates aberration characteristics of the example optical imaging system illustrated in FIG. 1.

FIG. 3 illustrates a configuration diagram of an example optical imaging system, in accordance with a second example embodiment.

FIG. 4 illustrates aberration characteristics of the example optical imaging system illustrated in FIG. 3.

FIG. 5 illustrates a configuration diagram of an example optical imaging system, in accordance with a third example embodiment.

FIG. 6 illustrates aberration characteristics of the example optical imaging system illustrated in FIG. 5.

Throughout the drawings and the detailed description, unless otherwise described or provided, it may be understood that the same drawing reference numerals may refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

One or more examples may provide an optical imaging system that can achieve high resolution and having a small overall length thereof.

In the one or more lens configuration example embodiments below, a thickness, a size, and a shape of a lens are somewhat exaggerated for explanation purposes, in particular, a spherical or aspherical shape illustrated in the lens configuration diagram is illustrative, but is not limited thereto.

A first lens refers to a lens closest to an object side, and an eighth lens refers to a lens closest to an imaging plane (or an image sensor).

Additionally, in the one or more examples, values for a radius of curvature, a thickness, a distance, a focal length, or the like of a lens are all in millimeters (mm), and a unit of a field-of-view (FOV) is a degree.

Additionally, in the description of a shape of each lens, a shape in which one surface is convex means that a paraxial region of the one surface is convex, and a shape in which one surface is concave means that a paraxial region of the one surface is concave. Therefore, even if one surface of a lens is described as having a convex shape, an edge portion of the lens may be concave. Likewise, even if one surface of a lens is described as having a concave shape, an edge portion of the lens may be convex.

The paraxial region refers to a very narrow region near an optical axis.

The imaging plane may refer to a virtual plane on which a focus is formed by the optical imaging system. Alternatively, the imaging plane may refer to one surface of the image sensor that receives light.

An optical imaging system according to the one or more example embodiments may include eight lenses.

In an example, an optical imaging system according to an embodiment may include a first lens, a second lens, a third lens, a fourth lens, a fifth lens, a sixth lens, a seventh lens, and an eighth lens, sequentially arranged from an object side toward an imaging plane. The first to eighth lenses are spaced apart from each other, respectively, by a preset distance along an optical axis.

An optical imaging system according to the one or more embodiments may not include only eight lenses, and may further include other components, as needed.

In an example, the example optical imaging system may further include an image sensor that converts an incident image of a subject into an electrical signal.

Additionally, the example optical imaging system may further include an infrared filter (hereinafter referred to as a ‘filter’) that blocks infrared rays. The filter may be disposed between the eighth lens and the image sensor.

Additionally, the example optical imaging system may further include a stop to control an amount of light.

The first to eighth lenses constituting the example optical imaging system according to the one or more example embodiments may be formed of a plastic material.

Additionally, at least one lens among the first to eighth lenses may have an aspherical surface. Additionally, the first to eighth lenses may each have at least one aspherical surface.

In an example, at least one of an object-side surface and an image-side surface of the first to eighth lenses may be aspherical. In this example, the aspherical surfaces of the first to eighth lenses are expressed by Equation 1 below:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad Equation 1$$

In Equation 1, c is a curvature (reciprocal of a radius of curvature) of a lens, K is a conic constant, and Y represents a distance from a certain point on an aspherical surface of the lens to an optical axis. Additionally, the constants A-H, J, and L-P refer to an aspheric coefficient. Z (SAG) represents a distance in an optical axis direction between the certain point on the aspherical surface of the lens and a vertex of the aspherical surface.

An optical imaging system according to one or more example embodiments may satisfy at least one of the conditional expressions below.

In accordance with an embodiment, the optical imaging system may satisfy the condition TTL/(2×IMG HT)<0.64. In this example, TTL is a distance on an optical axis from an object-side surface of the first lens to an imaging plane, and IMG HT is half the diagonal length of the imaging plane. Therefore, the optical imaging system may be miniaturized.

In accordance with an embodiment, the optical imaging system may satisfy the condition 1.3<Fno<1.6. In this example, Fno is an F-number of the optical imaging system. Therefore, image brightness and resolution may be improved.

In accordance with an embodiment, the optical imaging system may satisfy the condition 25<v1−v2<45. In this example, v1 is an Abbe number of the first lens, and v2 is an Abbe number of the second lens.

In accordance with an embodiment, the optical imaging system may satisfy the condition 25<v1−v3<45. In this example, v3 is an Abbe number of the third lens.

In accordance with an embodiment, the optical imaging system may satisfy the condition 15<v1−(v2+v3)<25.

In accordance with an embodiment, the imaging lens satisfy the condition |v1−(v2+v3+v5)| <10. In this example, v5 is an Abbe number of the fifth lens.

In accordance with an embodiment, the optical imaging system may satisfy the condition 0.9<f1/f<1.2. In this example, f1 is a focal length of the first lens, and f is a total focal length of the optical imaging system.

In accordance with an embodiment, the optical imaging system may satisfy the condition −3<f2/f<−1. In this example, f2 is a focal length of the second lens.

In accordance with an embodiment, the optical imaging system may satisfy the condition |f3/f|>30. In this example, f3 is a focal length of the third lens.

In accordance with an embodiment, the optical imaging system may satisfy the condition 2.5<f4/f<5. In this example, f4 is a focal length of the fourth lens.

In accordance with an embodiment, the optical imaging system may satisfy the condition −10<f5/f<−4. In this example, f5 is a focal length of the fifth lens.

In accordance with an embodiment, the optical imaging system may satisfy the condition 0.3<|f1/f2|<0.6.

In accordance with an embodiment, the optical imaging system may satisfy the condition |f1/f3|<0.05.

In accordance with an embodiment, the optical imaging system may satisfy the condition |f2/f3|<0.08.

In accordance with an embodiment, the optical imaging system may satisfy the condition 1.3<f12/f<1.7. In this example, f12 is a composite focal length of the first lens and the second lens.

In accordance with an embodiment, the optical imaging system may satisfy the condition 1.3<f123/f<1.7. In this example, f123 is a composite focal length of the first lens, the second lens, and the third lens.

The first to eighth lenses constituting an example optical imaging system in accordance with one or more embodiments will be described.

The first lens may have positive refractive power. Furthermore, the first lens may have a meniscus shape that is convex toward the object side. Additionally, an object-side surface of the first lens may be convex, and an image-side surface of the first lens may be concave.

At least one of the object-side surface or the image-side surface of the first lens may be aspherical. In an example, both the object-side surface and the image-side surface of the first lens may be aspherical.

The second lens may have negative refractive power. Furthermore, the second lens may have a meniscus shape that is convex toward the object side. Additionally, an object-side surface of the second lens may be convex, and an image-side surface of the second lens may be concave.

At least one of the object-side surface or the image-side surface of the second lens may be aspherical. In an example, both the object-side surface and the image-side surface of the second lens may be aspherical.

The third lens may have positive or negative refractive power. Furthermore, the third lens may have a meniscus shape that is convex toward the object side. Additionally, an object-side surface of the third lens may be convex, and an image-side surface of the third lens may be concave.

At least one of the object-side surface or the image-side surface of the third lens may be aspherical. In an example, both the object-side surface and the image-side surface of the third lens may be aspherical.

The fourth lens may have positive refractive power. Furthermore, the fourth lens may have a meniscus shape that is convex toward the image side. Additionally, an object-side surface of the fourth lens may be concave, and an image-side surface of the fourth lens may be convex.

At least one of the object-side surface or the image-side surface of the fourth lens may be aspherical. For example, both the object-side surface and the image-side surface of the fourth lens may be aspherical.

The fifth lens may have negative refractive power. Furthermore, the fifth lens may have a meniscus shape that is convex toward the image side. An object-side surface of the fifth lens may be concave, and an image-side surface of the fifth lens may be convex.

At least one of the object-side surface or the image-side surface of the fifth lens may be aspherical. For example, both the object-side surface and the image-side surface of the fifth lens may be aspherical.

The sixth lens may have positive refractive power. Furthermore, the sixth lens may have a meniscus shape that is convex toward the object side. Additionally, an object-side surface of the sixth lens may be convex, and an image-side surface of the sixth lens may be concave.

At least one of the object-side surface or the image-side surface of the sixth lens may be aspherical. For example, both the object-side surface and the image-side surface of the sixth lens may be aspherical.

The sixth lens may have at least one inflection point formed on at least one of the object-side surface and the image-side surface. For example, the object-side surface of the sixth lens may be convex in a paraxial region and concave in a portion other than the paraxial region. The image-side surface of the sixth lens may be concave in a paraxial region and convex in a portion other than the paraxial region.

The seventh lens may have positive refractive power. Furthermore, the seventh lens may have a shape in which both surfaces thereof are convex. Additionally, an object-side surface and an image-side surface of the seventh lens may be convex.

At least one of the object-side surface or the image-side surface of the seventh lens may be aspherical. In an example, both the object-side surface and the image-side surface of the seventh lens may be aspherical.

Additionally, the seventh lens may have at least one inflection point formed on at least one of the object-side surface or the image-side surface. For example, the object-side surface of the seventh lens may be convex in a paraxial region and concave in a portion other than the paraxial region. The image-side surface of the seventh lens may be convex in a paraxial region and concave in a portion other than the paraxial region.

The eighth lens may have negative refractive power. Furthermore, the eighth lens may have a shape in which both surfaces thereof are concave. Additionally, an object-side surface and an image-side surface of the eighth lens may be concave.

At least one of the object-side surface or the image-side surface of the eighth lens may be aspherical. For example, both the object-side surface and the image-side surface of the eighth lens may be aspherical.

Additionally, the eighth lens may have at least one inflection point formed on at least one of the object-side surface or the image-side surface. In an example, the object-side surface of the eighth lens may be concave in a paraxial region and convex in a portion other than the paraxial region. The image-side surface of the eighth lens may be concave in a paraxial region and convex in a portion other than the paraxial region.

The second lens and the third lens may each be configured to have a greater refractive index than a refractive index of the first lens.

In an embodiment, the second lens and the third lens may each have a refractive index greater than 1.66.

Among the first to eighth lenses, at least three lenses including the second lens and the third lens may have a refractive index greater than 1.66. In an example, the second lens, the third lens, and the fifth lens may have a refractive index greater than 1.66, respectively.

In an embodiment, the refractive index of the fifth lens may be greater than the refractive index of the second lens and the refractive index of the third lens, respectively. In an example, the fifth lens may have a refractive index greater than 1.68.

In the example optical imaging system, among lenses having a refractive index greater than 1.66, at least two lenses may be configured to have negative refractive power.

In the example optical imaging system, among lenses having a refractive index greater than 1.66, an absolute value of a focal length of the second lens may be the smallest.

An Abbe number of the third lens may be less than 50, an Abbe number of the fourth lens may be greater than 50, and an Abbe number of the fifth lens may be less than 50.

Furthermore, an Abbe number of the seventh lens and an Abbe number of the eighth lens may each be greater than 50.

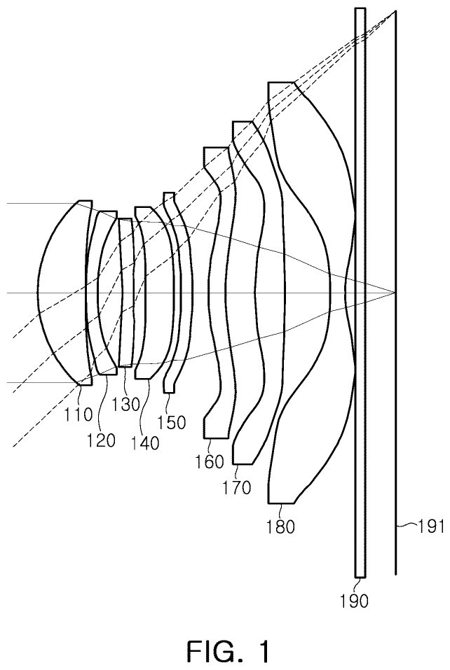

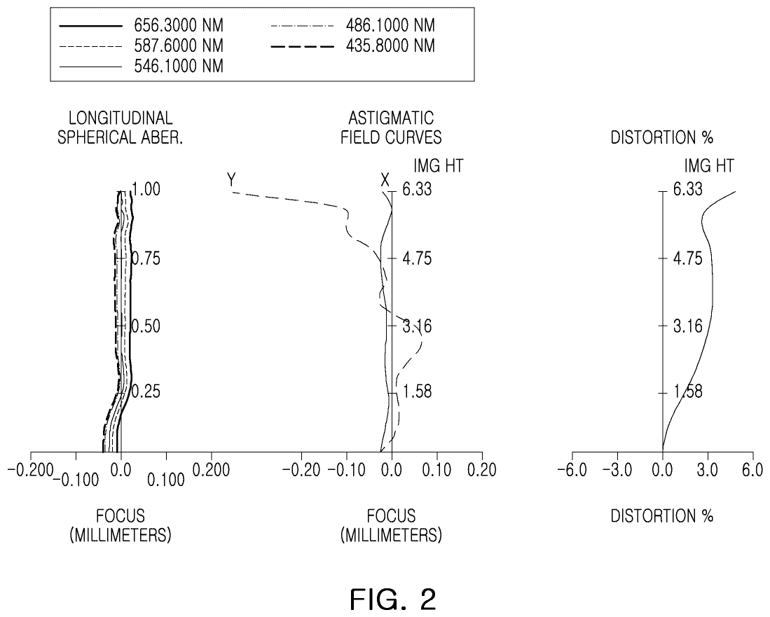

An example optical imaging system according to a first embodiment will be described with reference to FIGS. 1 and 2.

The example optical imaging system according to the first embodiment may include a first lens 110, a second lens 120, a third lens 130, a fourth lens 140, a fifth lens 150, a sixth lens 160, a seventh lens 170, and an eighth lens 180, and may further include a filter 190 and an image sensor.

The optical imaging system according to the first embodiment may form a focus (or focus an image) on an imaging plane 191. The imaging plane 191 may refer to a surface on which a focus is formed by the optical imaging system. As an example, the imaging plane 191 may refer to one surface of the image sensor that receives light.

Lens characteristics of each lens (a radius of curvature, a thickness of a lens or a distance between lenses, a refractive index, an Abbe number, or an effective radius) are illustrated in Table 1 below.

TABLE 1

| Surface | | Curvature | Thickness or | Refractive | | Effective |
|---|---|---|---|---|---|---|
| No. | Component | Radius | Distance | Index | Abbe No. | Radius |
| S1 | 1st Lens | 2.833 | 1.022 | 1.5463 | 55.99 | 2.060 |
| S2 | | 13.581 | 0.030 | | | 1.955 |
| S3 | 2nd Lens | 6.308 | 0.230 | 1.6789 | 19.24 | 1.853 |
| S4 | | 3.804 | 0.518 | | | 1.671 |
| S5 | 3rd Lens | 24.920 | 0.282 | 1.6789 | 19.24 | 1.660 |
| S6 | | 26.058 | 0.242 | | | 1.660 |
| S7 | 4th Lens | −224.294 | 0.633 | 1.5463 | 55.99 | 1.730 |
| S8 | | −11.048 | 0.143 | | | 1.932 |
| S9 | 5th Lens | −10.328 | 0.239 | 1.6892 | 18.15 | 2.154 |
| S10 | | −14.338 | 0.362 | | | 2.228 |
| S11 | 6th Lens | 3.999 | 0.366 | 1.5707 | 37.40 | 2.843 |
| S12 | | 4.482 | 0.647 | | | 3.267 |
| S13 | 7th Lens | 6.378 | 0.640 | 1.5371 | 55.74 | 3.463 |
| S14 | | −9.640 | 0.988 | | | 3.877 |
| S15 | 8th Lens | −10.942 | 0.353 | 1.5371 | 55.74 | 4.357 |
| S16 | | 3.067 | 0.200 | | | 4.729 |
| S17 | Filter | Infinity | 0.210 | | | 5.724 |
| S18 | | Infinity | 0.662 | | | 5.814 |
| S19 | Imaging | Infinity | | | | 6.335 |
| | Plane | | | | | |

In the first embodiment, the first lens 110 may have positive refractive power, an object-side surface of the first lens 110 may be convex, and an image-side surface of the first lens 110 may be concave.

The second lens 120 may have negative refractive power, an object-side surface of the second lens 120 may be convex, and an image-side surface of the second lens 120 may be concave.

The third lens 130 may have positive refractive power, an object-side surface of the third lens 130 may be convex, and an image-side surface of the third lens 130 may be concave.

The fourth lens 140 may have positive refractive power, an object-side surface of the fourth lens 140 may be concave, and an image-side surface of the fourth lens 140 may be convex.

The fifth lens 150 may have negative refractive power, an object-side surface of the fifth lens 150 may be concave, and an image-side surface of the fifth lens 150 may be convex.

The sixth lens 160 may have positive refractive power, an object-side surface of the sixth lens 160 may be convex, and an image-side surface of the sixth lens 160 may be concave.

Furthermore, the sixth lens 160 may have at least one inflection point formed on at least one of the object-side surface or the image-side surface thereof. In an example, the object-side surface of the sixth lens 160 may be convex in a paraxial region and concave in a portion other than the paraxial region. Additionally, the image-side surface of the sixth lens 160 may be concave in a paraxial region and convex in a portion other than the paraxial region.

The seventh lens 170 may have positive refractive power, and an object-side surface and an image-side surface of the seventh lens 170 may be convex in a paraxial region.

Furthermore, the seventh lens 170 may have at least one inflection point formed on at least one of the object-side surface or the image-side surface. For example, the object-side surface of the seventh lens 170 may be convex in a paraxial region and concave in a portion other than the paraxial region. Additionally, the image-side surface of the seventh lens 170 may be convex in a paraxial region and concave in a portion other than the paraxial region.

The eighth lens 180 may have negative refractive power, and an object-side surface and an image-side surface of the eighth lens 180 may be concave in a paraxial region.

Furthermore, the eighth lens 180 may have at least one inflection point formed on at least one of the object-side surface or the image-side surface. In an example, the object-side surface of the eighth lens 180 may be concave in a paraxial region and convex in a portion other than the paraxial region. Additionally, the image-side surface of the eighth lens 180 may be concave in a paraxial region and convex in a portion other than the paraxial region.

Each surface of the first lens 110 to the eighth lens 180 may have an aspherical coefficient, as illustrated in Table 2 below. In an example, both the object-side surface and the image-side surface of the first lens 110 to the eighth lens 180 may be aspherical.

TABLE 2

| | S1 | S2 | S3 | S4 | S5 | S6 | S7 | S8 |
|---|---|---|---|---|---|---|---|---|
| Conic | −0.4617 | 9.7151 | 9.9950 | 1.8381 | 58.1439 | 67.4793 | 0 | 13.8497 |
| Constant K | | | | | | | | |
| 4th | −6.605E−03 | −2.257E−02 | −3.052E−02 | −2.455E−02 | −2.762E−02 | −3.043E−02 | −1.533E−02 | 1.267E−02 |
| Coefficient A | | | | | | | | |
| 6th | 4.233E−02 | 6.911E−02 | 1.560E−02 | 8.912E−02 | 7.618E−02 | 7.739E−02 | 1.359E−02 | 9.711E−03 |
| Coefficient B | | | | | | | | |
| 8th | −1.096E−01 | −1.614E−01 | 1.112E−01 | −3.633E−01 | −3.757E−01 | −3.168E−01 | −3.339E−02 | −2.338E−01 |
| Coefficient C | | | | | | | | |
| 10th | 1.831E−01 | 2.970E−01 | −4.718E−01 | 9.829E−01 | 1.161E+00 | 8.124E−01 | 7.612E−03 | 7.100E−01 |
| Coefficient D | | | | | | | | |
| 12th | −2.067E−01 | 1−4.036E−01 | 1.003E+00 | −1.754E+00 | −2.443E+00 | −1.428E+00 | 1.085E−01 | −1.245E+00 |
| Coefficient E | | | | | | | | |
| 14th | 1.637E−01 | 3.979E−01 | −1.372E+00 | 2.140E+00 | 3.615E+00 | 1.800E+00 | −2.758E−01 | 1.454E+00 |
| Coefficient E | | | | | | | | |
| 16th | −9.315E−02 | −2.855E−01 | 1.294E+00 | −1.830E+00 | −3.831E+00 | −1.668E+00 | 3.655E−01 | −1.190E+00 |
| Coefficient G | | | | | | | | |
| 18th | 3.858E−02 | 1.498E−01 | −8.647E−01 | 1.111E+00 | 2.933E+00 | 1.152E+00 | −3.101E−01 | 6.984E−01 |
| Coefficient H | | | | | | | | |
| 20th | −1.166E−02 | −5.740E−02 | 4.132E−01 | −4.767E−01 | −1.621E+00 | −5.934E−01 | 1.784E−01 | −2.957E−01 |
| Coefficient J | | | | | | | | |
| 22nd | 2.548E−03 | 1.586E−02 | −1.402E−01 | 1.418E−01 | 6.396E−01 | 2.247E−01 | −7.051E−02 | 8.953E−02 |
| Coefficient L | | | | | | | | |
| 24th | −3.927E−04 | −3.074E−03 | 3.302E−02 | −2.787E−02 | −1.754E−01 | −6.071E−02 | 1.890E−02 | −1.892E−02 |
| Coefficient M | | | | | | | | |
| 26th | 4.054E−05 | 3.963E−04 | −5.125E−03 | 3.273E−03 | 3.173E−02 | 1.105E−02 | −3.284E−03 | 2.648E−03 |
| Coefficient N | | | | | | | | |
| 28th | −2.518E−06 | −3.049E−05 | 4.717E−04 | −1.774E−04 | −3.402E−03 | −1.212E−03 | 3.337E−04 | −2.208E−04 |
| Coefficient O | | | | | | | | |
| 30th | 7.123E−08 | 1.058E−06 | −1.950E−05 | 6.541E−07 | 1.635E−04 | 6.042E−05 | −1.503E−05 | 8.293E−06 |
| Coefficient P | | | | | | | | |

| | S9 | S10 | S11 | S12 | S13 | S14 | S15 | S16 |
|---|---|---|---|---|---|---|---|---|
| Conic | 0 | 0 | 0 | 0 | 1.4712 | 0 | 0 | −4.9687 |
| Constant K | | | | | | | | |
| 4th | 6.187E−02 | 4.212E−02 | −1.566E−02 | −2.726E−02 | 9.430E−03 | 3.452E−02 | −5.536E−02 | −4.766E−02 |
| Coefficient A | | | | | | | | |
| 6th | −1.417E−01 | −1.139E−01 | −1.956E−02 | −2.310E−03 | −1.349E−02 | −1.252E−02 | 1.110E−02 | 1.239E−02 |
| Coefficient B | | | | | | | | |
| 8th | 1.940E−01 | 1.721E−01 | 3.587E−02 | 9.304E−03 | 7.221E−03 | 2.955E−03 | −1.489E−03 | −1.772E−03 |
| Coefficient C | | | | | | | | |
| 10th | −2.314E−01 | −2.222E−01 | −3.730E−02 | −6.406E−03 | −3.372E−03 | −5.965E−04 | 9.922E−05 | −1.152E−04 |
| Coefficient D | | | | | | | | |
| 12th | 2.199E−01 | 2.247E−01 | 2.730E−02 | 2.487E−03 | 1.168E−03 | 7.335E−05 | 2.952E−05 | 1.253E−04 |
| Coefficient E | | | | | | | | |
| 14th | −1.578E−01 | −1.710E−01 | −1.465E−02 | −6.213E−04 | −2.866E−04 | 1.131E−05 | −8.903E−06 | −3.172E−05 |
| Coefficient F | | | | | | | | |
| 16th | 8.363E−02 | 9.689E−02 | 5.785E−03 | 1.040E−04 | 4.818E−05 | −8.717E−06 | 1.010E−06 | 4.730E−06 |
| Coefficient G | | | | | | | | |
| 18th | −3.225E−02 | −4.069E−02 | −1.672E−03 | −1.182E−05 | −5.437E−06 | 2.255E−06 | −4.733E−08 | −4.707E−07 |
| Coefficient H | | | | | | | | |
| 20th | 8.928E−03 | 1.258E−02 | 3.506E−04 | 9.066E−07 | 4.031E−07 | −3.398E−07 | −1.109E−09 | 3.246E−08 |
| Coefficient J | | | | | | | | |
| 22nd | −1.742E−03 | −2.818E−03 | −5.251E−05 | −4.520E−08 | −1.883E−08 | 3.266E−08 | 2.811E−10 | −1.557E−09 |
| Coefficient L | | | | | | | | |
| 24th | 2.326E−04 | 4.444E−04 | 5.458E−06 | 1.333E−09 | 5.023E−10 | −2.033E−09 | −1.713E−11 | 5.105E−11 |
| Coefficient M | | | | | | | | |
| 26th | −2.016E−05 | −4.672E−05 | −3.732E−07 | −1.776E−11 | −5.843E−12 | 7.957E−11 | 5.456E−13 | −1.089E−12 |
| Coefficient N | | | | | | | | |
| 28th | 1.023E−06 | 2.934E−06 | 1.507E−08 | 0 | 0 | −1.785E−12 | −9.262E−15 | 1.362E−14 |
| Coefficient O | | | | | | | | |
| 30th | −2.322E−08 | −8.320E−08 | −2.721E−10 | 0 | 0 | 1.754E−14 | 6.645E−17 | −7.571E−17 |
| Coefficient P | | | | | | | | |

Furthermore, the example optical imaging system configured as described above may have aberration characteristics as illustrated in FIG. 2.

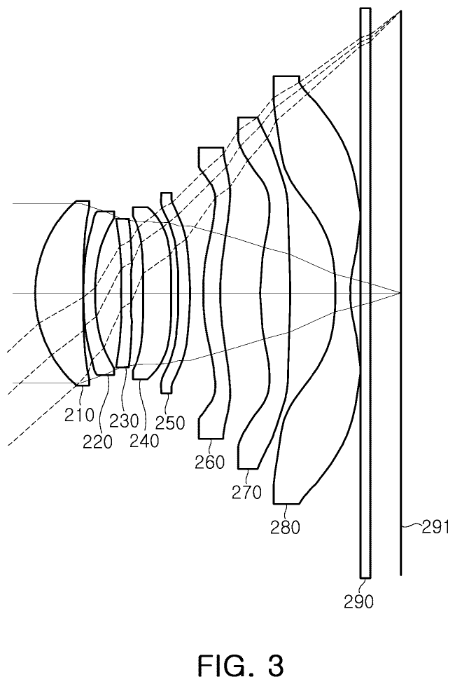

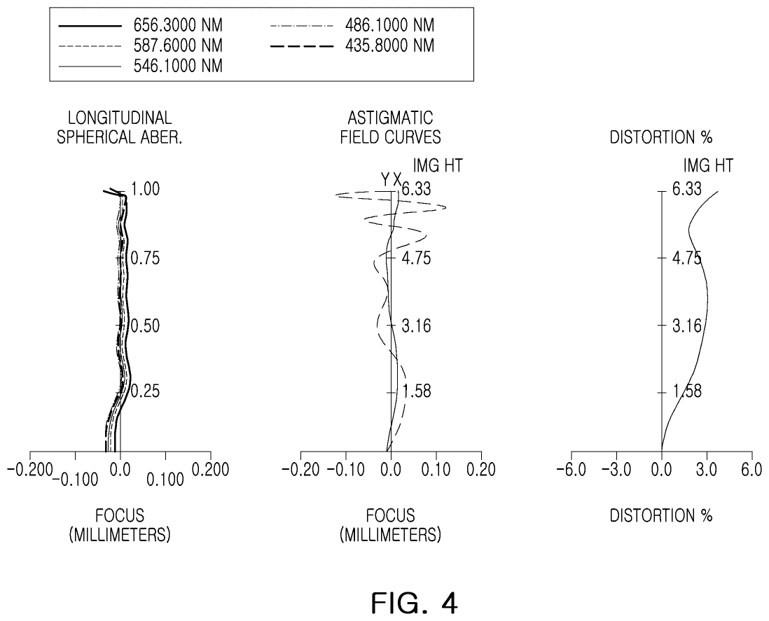

An example optical imaging system according to a second embodiment will be described with reference to FIGS. 3 and 4.

The example optical imaging system 200 according to the second embodiment may include a first lens 210, a second lens 220, a third lens 230, a fourth lens 240, a fifth lens 250, a sixth lens 260, a seventh lens 270, and an eighth lens 280, and may further include a filter 290 and an image sensor.

The example optical imaging system according to the second embodiment may form a focus (or focus an image) on an imaging plane 291. The imaging plane 291 may refer to a surface on which a focus is formed by the optical imaging system. As In an example, the imaging plane 291 may refer to one surface of the image sensor that receives light.

Lens characteristics of each lens (a radius of curvature, a thickness of a lens or a distance between lenses, a refractive index, an Abbe number, or an effective radius) are illustrated in Table 3 below.

TABLE 3

| Surface | | Curvature | Thickness or | Refractive | | Effective |
|---|---|---|---|---|---|---|
| No. | Component | Radius | Distance | Index | Abbe No. | Radius |
| S1 | 1st Lens | 2.832 | 1.008 | 1.5463 | 55.99 | 2.053 |
| S2 | | 13.538 | 0.047 | | | 1.952 |
| S3 | 2nd Lens | 6.293 | 0.230 | 1.6789 | 19.24 | 1.859 |
| S4 | | 3.918 | 0.545 | | | 1.692 |
| S5 | 3rd Lens | 39.233 | 0.238 | 1.6789 | 19.24 | 1.682 |
| S6 | | 32.694 | 0.258 | | | 1.649 |
| S7 | 4th Lens | −116.716 | 0.645 | 1.5463 | 55.99 | 1.612 |
| S8 | | −10.004 | 0.108 | | | 1.777 |
| S9 | 5th Lens | −11.620 | 0.230 | 1.6892 | 18.15 | 1.934 |
| S10 | | −23.516 | 0.338 | | | 2.078 |
| S11 | 6th Lens | 3.993 | 0.361 | 1.5707 | 37.40 | 2.686 |
| S12 | | 4.667 | 0.714 | | | 3.123 |
| S13 | 7th Lens | 6.350 | 0.680 | 1.5371 | 55.74 | 3.575 |
| S14 | | −9.860 | 1.001 | | | 3.922 |
| S15 | 8th Lens | −11.740 | 0.301 | 1.5371 | 55.74 | 4.376 |
| S16 | | 2.901 | 0.194 | | | 4.695 |
| S17 | Filter | Infinity | 0.210 | | | 5.713 |
| S18 | | Infinity | 0.700 | | | 5.803 |
| S19 | Imaging | Infinity | | | | 6.333 |
| | Plane | | | | | |

In the second embodiment, the first lens 210 may have positive refractive power, an object-side surface of the first lens 210 may be convex, and an image-side surface of the first lens 210 may be concave.

The second lens 220 may have negative refractive power, an object-side surface of the second lens 220 may be convex, and an image-side surface of the second lens 220 may be concave.

The third lens 230 may have negative refractive power, an object-side surface of the third lens 230 may be convex, and an image-side surface of the third lens 230 may be concave.

The fourth lens 240 may have positive refractive power, an object-side surface of the fourth lens 240 may be concave, and an image-side surface of the fourth lens 240 may be convex.

The fifth lens 250 may have negative refractive power, an object-side surface of the fifth lens 250 may be concave, and an image-side surface of the fifth lens 250 may be convex.

The sixth lens 260 may have positive refractive power, an object-side surface of the sixth lens 260 may be convex, and an image-side surface of the sixth lens 260 may be concave. Furthermore, the sixth lens 260 may have at least one inflection point formed on at least one of the object-side surface or the image-side surface. In an example, the object-side surface of the sixth lens 260 may be convex in a paraxial region and concave in a portion other than the paraxial region. Additionally, the image-side surface of the sixth lens 260 may be concave in a paraxial region and convex in a portion other than the paraxial region.

The seventh lens 270 may have positive refractive power, and an object-side surface and an image-side surface of the seventh lens 270 may be convex in a paraxial region.

Furthermore, the seventh lens 270 may have at least one inflection point formed on at least one of the object-side surface or the image-side surface. In an example, the object-side surface of the seventh lens 270 may be convex in a paraxial region and concave in a portion other than the paraxial region. The image-side surface of the seventh lens 270 may be convex in a paraxial region and concave in a portion other than the paraxial region.

The eighth lens 280 may have negative refractive power, and an object-side surface and an image-side surface of the eighth lens 280 may be concave in a paraxial region.

Furthermore, the eighth lens 280 may have at least one inflection point formed on at least one of the object-side surface or the image-side surface. In an example, the object-side surface of the eighth lens 280 may be concave in a paraxial region and convex in a portion other than the paraxial region. The image-side surface of the eighth lens 280 may be concave in a paraxial region and convex in a portion other than the paraxial region.

Each surface of the first lens 210 to the eighth lens 280 may have an aspherical coefficient, as illustrated in Table 4 below. In an example, both the object-side surface and the image-side surface of the first lens 210 to the eighth lens 280 may be aspherical.

TABLE 4

| | S1 | S2 | S3 | S4 | S5 | S6 | S7 | S8 |
|---|---|---|---|---|---|---|---|---|
| Conic | −0.4385 | 8.8287 | 10.0141 | 1.9458 | 13.9479 | 43.0228 | 0 | 13.5255 |
| Constant K | | | | | | | | |
| 4th | −5.141E−03 | −2.145E−02 | −2.590E−02 | −1.148E−02 | −1.945E−02 | −2.104E−02 | 1.138E−02 | 2.915E−02 |
| Coefficient A | | | | | | | | |
| 6th | 3.731E−02 | 1.032E−01 | −8.006E−03 | −4.826E−02 | −3.484E−02 | −4.355E−02 | −1.870E−01 | −1.037E−01 |
| Coefficient B | | | | | | | | |
| 8th | −1.061E−01 | −4.125E−01 | 1.477E−01 | 3.183E−01 | 2.445E−01 | 3.586E−01 | 7.787E−01 | 1.071E−01 |
| Coefficient C | | | | | | | | |
| 10th | 2.011E−01 | 1.090E+00 | 4.309E−01 | −1.014E+00 | −9.145E−01 | −1.502E+00 | −2.109E+00 | 7.813E−02 |
| Coefficient D | | | | | | | | |
| 12th | −2.608E−01 | −1.871E+00 | 7.426E−01 | 2.095E+00 | 2.114E+00 | 3.819E+00 | 3.914E+00 | −4.458E−01 |
| Coefficient E | | | | | | | | |
| 14th | 2.381E−01 | 2.171E+00 | −8.772E−01 | −3.016E+00 | −3.264E+00 | −6.395E+00 | −5.147E+00 | 7.286E−01 |
| Coefficient F | | | | | | | | |
| 16th | −1.557E−01 | −1.757E+00 | 7.461E−01 | 3.120E+00 | 3.511E+00 | 7.380E+00 | 4.886E+00 | −7.052E−01 |
| Coefficient G | | | | | | | | |
| 18th | 7.362E−02 | 1.011E+00 | −4.649E−01 | −2.348E+00 | −2.691E+00 | −6.012E+00 | −3.374E+00 | 4.569E−01 |
| Coefficient H | | | | | | | | |
| 20th | −2.518E−02 | −4.162E−01 | 2.123E−01 | 1.286E+00 | 1.480E+00 | 3.489E+00 | 1.694E+00 | −2.062E−01 |
| Coefficient J | | | | | | | | |
| 22nd | 6.162E−03 | 1.218E−01 | −7.020E−02 | −5.062E−01 | −5.806E−01 | −1.434E+00 | −6.114E−01 | 6.526E−02 |
| Coefficient L | | | | | | | | |
| 24th | −1.051E−03 | −2.472E−02 | 1.632E−02 | 1.395E−01 | 1.586E−01 | 4.078E−01 | 1.544E−01 | −1.424E−02 |
| Coefficient M | | | | | | | | |
| 26th | 1.186E−04 | 3.310E−03 | −2.527E−03 | −2.553E−02 | −2.871E−02 | −7.638E−02 | −2.587E−02 | 2.042E−03 |
| Coefficient N | | | | | | | | |
| 28th | −7.948E−06 | −2.629E−04 | 2.337E−04 | 2.785E−03 | 3.094E−03 | 8.474E−03 | 2.584E−03 | −1.736E−04 |
| Coefficient O | | | | | | | | |
| 30th | 2.395E−07 | 9.378E−06 | −9.759E−06 | −1.371E−04 | −1.504E−04 | −4.218E−04 | −1.164E−04 | 6.627E−06 |
| Coefficient P | | | | | | | | |

| | S9 | S10 | S11 | S12 | S13 | S14 | S15 | S16 |
|---|---|---|---|---|---|---|---|---|
| Conic | 0 | 0 | 0 | 0 | 1.4602 | 0 | 0 | −4.8779 |
| Constant K | | | | | | | | |
| 4th | 7.932E−02 | 6.138E−02 | −1.797E−02 | −2.615E−02 | 1.153E−02 | 4.049E−02 | −6.022E−02 | −5.652E−02 |
| Coefficient A | | | | | | | | |
| 6th | −2.219E−01 | −2.040E−01 | −2.864E−02 | −1.190E−02 | −1.493E−02 | −2.020E−02 | 9.318E−03 | 1.682E−02 |
| Coefficient B | | | | | | | | |
| 8th | 3.479E−01 | 3.787E−01 | 5.059E−02 | 2.084E−02 | 7.581E−03 | 9.732E−03 | 3.060E−03 | −3.025E−03 |
| Coefficient C | | | | | | | | |
| 10th | −3.825E−01 | −5.164E−01 | −4.856E−02 | −1.352E−02 | −3.437E−03 | −4.733E−03 | −2.678E−03 | 1.299E−04 |
| Coefficient D | | | | | | | | |
| 12th | 2.754E−01 | 5.116E−01 | 3.294E−02 | 5.358E−03 | 1.199E−03 | 1.765E−03 | 9.438E−04 | 8.471E−05 |
| Coefficient E | | | | | | | | |
| 14th | −1.162E−01 | −3.720E−01 | −1.677E−02 | −1.429E−03 | −2.978E−04 | −4.621E−04 | −1.991E−04 | −2.536E−05 |
| Coefficient F | | | | | | | | |
| 16th | 1.388E−02 | 2.005E−01 | 6.435E−03 | 2.626E−04 | 5.050E−05 | 8.441E−05 | 2.776E−05 | 3.861E−06 |
| Coefficient G | | | | | | | | |
| 18th | 1.497E−02 | −8.038E−02 | −1.844E−03 | −3.332E−05 | −5.730E−06 | −1.083E−05 | −2.683E−06 | −3.791E−07 |
| Coefficient H | | | | | | | | |
| 20th | −1.074E−02 | 2.384E−02 | 3.886E−04 | 2.868E−06 | 4.268E−07 | 9.802E−07 | 1.832E−07 | 2.546E−08 |
| Coefficient J | | | | | | | | |
| 22nd | 3.714E−03 | −5.153E−03 | −5.896E−05 | −1.601E−07 | −2.003E−08 | −6.202E−08 | −8.852E−09 | −1.181E−09 |
| Coefficient L | | | | | | | | |
| 24th | −7.831E−04 | 7.880E−04 | 6.237E−06 | 5.225E−09 | 5.374E−10 | 2.680E−09 | 2.964E−10 | 3.723E−11 |
| Coefficient M | | | | | | | | |
| 26th | 1.022E−04 | −8.068E−05 | −4.351E−07 | −7.577E−11 | −6.294E−12 | −7.510E−11 | −6.552E−12 | −7.597E−13 |
| Coefficient N | | | | | | | | |
| 28th | −7.606E−06 | 4.956E−06 | 1.794E−08 | 0 | 0 | 1.225E−12 | 8.606E−14 | 9.027E−15 |
| Coefficient O | | | | | | | | |
| 30th | 2.479E−07 | −1.380E−07 | −3.305E−10 | 0 | 0 | −8.780E−15 | −5.088E−16 | −4.726E−17 |
| Coefficient P | | | | | | | | |

Furthermore, the example optical imaging system configured as described above may have aberration characteristics as illustrated in FIG. 4.

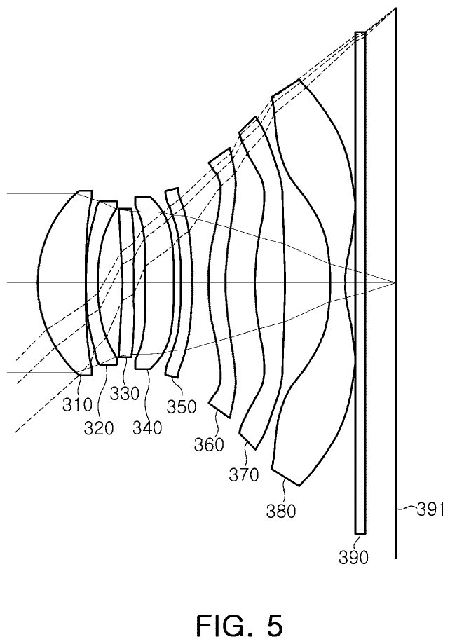

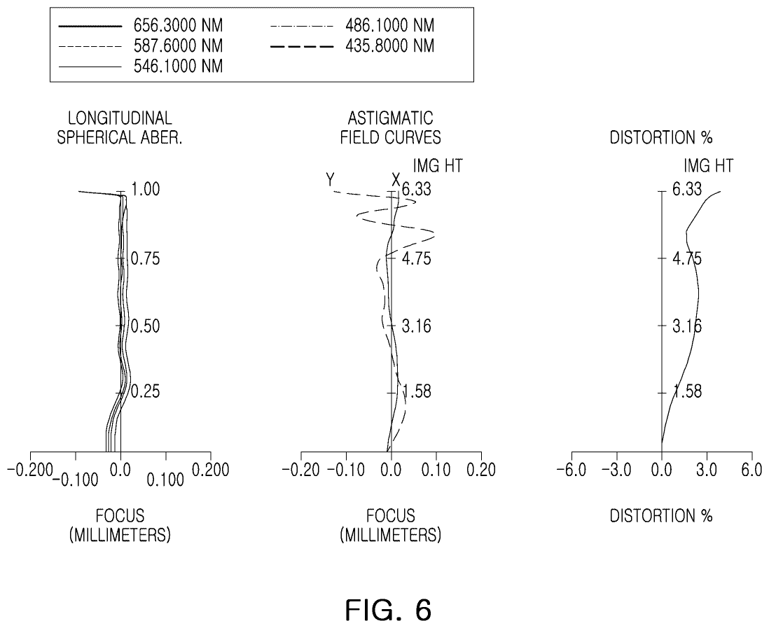

An example optical imaging system according to a third embodiment will be described with reference to FIGS. 5 and 6.

The example optical imaging system 300 according to the third embodiment may include a first lens 310, a second lens 320, a third lens 330, a fourth lens 340, a fifth lens 350, a sixth lens 360, a seventh lens 370, and an eighth lens 380, and may further include a filter 390 and an image sensor.

The optical imaging system according to the third embodiment may form a focus (or focus an image) on an imaging plane 391. The imaging plane 391 may refer to a surface on which a focus is formed by the optical imaging system. In an example, the imaging plane 391 may refer to one surface of the image sensor that receives light.

Lens characteristics of each lens (a radius of curvature, a thickness of a lens or a distance between lenses, a refractive index, an Abbe number, or an effective radius) are illustrated in Table 5 below.

TABLE 5

| Surface | | Curvature | Thickness or | Refractive | | Effective |
|---|---|---|---|---|---|---|
| No. | Component | Radius | Distance | Index | Abbe No. | Radius |
| S1 | 1st Lens | 2.832 | 1.004 | 1.5463 | 55.99 | 2.040 |
| S2 | | 13.528 | 0.049 | | | 1.946 |
| S3 | 2nd Lens | 6.290 | 0.230 | 1.6789 | 19.24 | 1.855 |
| S4 | | 3.945 | 0.540 | | | 1.694 |
| S5 | 3rd Lens | 45.138 | 0.246 | 1.6789 | 19.24 | 1.680 |
| S6 | | 37.615 | 0.262 | | | 1.645 |
| S7 | 4th Lens | −78.965 | 0.680 | 1.5463 | 55.99 | 1.698 |
| S8 | | −9.861 | 0.122 | | | 1.929 |
| S9 | 5th Lens | −10.602 | 0.230 | 1.6892 | 18.15 | 2.114 |
| S10 | | −20.632 | 0.352 | | | 2.205 |
| S11 | 6th Lens | 3.805 | 0.402 | 1.5371 | 55.74 | 2.724 |
| S12 | | 4.443 | 0.689 | | | 3.164 |
| S13 | 7th Lens | 6.298 | 0.677 | 1.5371 | 55.74 | 3.483 |
| S14 | | −10.214 | 0.981 | | | 3.893 |
| S15 | 8th Lens | −12.235 | 0.308 | 1.5371 | 55.74 | 4.321 |
| S16 | | 2.801 | 0.198 | | | 4.700 |
| S17 | Filter | Infinity | 0.210 | | | 5.705 |
| S18 | | Infinity | 0.673 | | | 5.795 |
| S19 | Imaging | Infinity | 0.027 | | | 6.329 |
| | Plane | | | | | |

In the third embodiment, the first lens 310 may have positive refractive power, an object-side surface of the first lens 310 may be convex, and an image-side surface of the first lens 310 may be concave.

The second lens 320 may have negative refractive power, an object-side surface of the second lens 320 may be convex, and an image-side surface of the second lens 320 may be concave.

The third lens 330 may have negative refractive power, an object-side surface of the third lens 330 may be convex, and an image-side surface of the third lens 330 may be concave. The fourth lens 340 may have positive refractive power, an object-side surface of the fourth lens 340 may be concave, and an image-side surface of the fourth lens 340 may be convex.

The fifth lens 350 may have negative refractive power, an object-side surface of the fifth lens 350 may be concave, and an image-side surface of the fifth lens 350 may be convex.

The sixth lens 360 may have positive refractive power, an object-side surface of the sixth lens 360 may be convex, and an image-side surface of the sixth lens 360 may be concave.

Furthermore, the sixth lens 360 may have at least one inflection point formed on at least one of the object-side surface or the image-side surface. For example, the object-side surface of the sixth lens 360 may be convex in a paraxial region and concave in a portion other than the paraxial region. The image-side surface of the sixth lens 360 may be concave in a paraxial region and convex in a portion other than the paraxial region.

The seventh lens 370 may have positive refractive power, and an object-side surface and an image-side surface of the seventh lens 370 may be convex in a paraxial region.

Furthermore, the seventh lens 370 may have at least one inflection point formed on at least one of the object-side surface or the image-side surface. In an example, the object-side surface of the seventh lens 370 may be convex in a paraxial region and concave in a portion other than the paraxial region. The image-side surface of the seventh lens 370 may be convex in a paraxial region and concave in a portion other than the paraxial region.

The eighth lens 380 may have negative refractive power, and an object-side surface and an image-side surface of the eighth lens 380 may be concave.

Furthermore, the eighth lens 380 may have at least one inflection point formed on at least one of the object-side surface or the image-side surface. In an example, the object-side surface of the eighth lens 380 may be concave in a paraxial region and convex in a portion other than the paraxial region. The image-side surface of the eighth lens 380 may be concave in a paraxial region and convex in a portion other than the paraxial region.

Each surface of the first lens 310 to the eighth lens 380 may have an aspherical coefficient, as illustrated in Table 6 below. In an example, both the object-side surface and the image-side surface of the first lens 310 to the eighth lens 380 may be aspherical.

TABLE 6

| | S1 | S2 | S3 | S4 | S5 | S6 | S7 | S8 |
|---|---|---|---|---|---|---|---|---|
| Conic | −0.4419 | 8.9994 | 10.0172 | 1.9520 | 4.5487 | 40.4614 | 0 | 13.5180 |
| Constant K | | | | | | | | |
| 4th | −6.650E−03 | −1.205E−02 | −2.394E−02 | −9.797E−03 | −1.587E−02 | −2.464E−02 | 1.195E−02 | 2.703E−02 |
| Coefficient A | | | | | | | | |
| 6th | 3.283E−02 | 2.557E−02 | −1.972E−02 | −6.239E−02 | −5.845E−02 | 1.805E−02 | −2.111E−01 | −9.816E−02 |
| Coefficient B | | | | | | | | |
| 8th | −6.050E−02 | −1.180E−01 | 1.399E−01 | 3.717E−01 | 2.854E−01 | −7.497E−02 | 9.315E−01 | 1.314E−01 |
| Coefficient C | | | | | | | | |
| 10th | 6.317E−02 | 4.315E−01 | −2.516E−01 | −1.136E+00 | −8.327E−01 | 1.557E−01 | −2.580E+00 | −6.639E−02 |
| Coefficient D | | | | | | | | |
| 12th | −3.042E−02 | −9.076E−01 | 1.948E−01 | 2.302E+00 | 1.614E+00 | −1.236E−01 | 4.778E+00 | −9.908E−02 |
| Coefficient E | | | | | | | | |
| 14th | −7.814E−03 | 1.195E+00 | 1.248E−02 | −3.322E+00 | −2.203E+00 | −1.273E−01 | −6.173E+00 | 2.325E−01 |
| Coefficient F | | | | | | | | |
| 16th | 2.287E−02 | 1.054E+00 | −1.741E−01 | 3.502E+00 | 2.183E+00 | 4.387E−01 | 5.700E+00 | −2.359E−01 |
| Coefficient G | | | | | | | | |
| 18th | −1.739E−02 | 6.455E−01 | 1.828E−01 | −2.720E+00 | −1.595E+00 | −5.393E−01 | −3.807E+00 | 1.500E−01 |
| Coefficient H | | | | | | | | |
| 20th | 7.774E−03 | −2.791E−01 | −1.060E−01 | 1.549E+00 | 8.592E−01 | 3.943E−01 | 1.841E+00 | −6.493E−02 |
| Coefficient J | | | | | | | | |
| 22nd | −2.279E−03 | 8.499E−02 | 3.940E−02 | −6.379E−01 | −3.377E−01 | −1.879E−01 | −6.380E−01 | 1.952E−02 |
| Coefficient K | | | | | | | | |
| 24th | 4.455E−04 | −1.786E−02 | −9.615E−03 | 1.845E−01 | 9.417E−02 | 5.915E−02 | 1.543E−01 | −4.029E−03 |
| Coefficient M | | | | | | | | |
| 26th | −5.613E−05 | 2.467E−03 | 1.495E−03 | −3.548E−02 | −1.765E−02 | −1.190E−02 | −2.473E−02 | 5.464E−04 |
| Coefficient N | | | | | | | | |
| 28th | 4.139E−06 | −2.015E−04 | −1.345E−04 | 4.072E−03 | 1.995E−03 | 1.390E−03 | 2.358E−03 | −4.397E−05 |
| Coefficient O | | | | | | | | |
| 30th | −1.359E−07 | 7.381E−06 | 5.331E−06 | −2.109E−04 | −1.027E−04 | −7.182E−05 | −1.012E−04 | 1.595E−06 |
| Coefficient P | | | | | | | | |

| | S9 | S10 | S11 | S12 | S13 | S14 | S15 | S16 |
|---|---|---|---|---|---|---|---|---|
| Conic | 0 | 0 | 0 | 0 | 1.4646 | 0 | 0 | −5.4055 |
| Constant K | | | | | | | | |
| 4th | 8.848E−02 | 5.960E−02 | −1.292E−02 | −2.271E−02 | 1.382E−02 | 4.117E−02 | −6.295E−02 | −6.032E−02 |
| Coefficient A | | | | | | | | |
| 6th | −2.798E−01 | −2.067E−01 | −4.467E−02 | −1.699E−02 | −1.935E−02 | −2.055E−02 | 9.727E−03 | 2.148E−02 |
| Coefficient B | | | | | | | | |
| 8th | 5.347E−01 | 3.853E−01 | 7.675E−02 | 2.522E−02 | 1.127E−02 | 9.048E−03 | 5.255E−03 | −5.490E−03 |
| Coefficient C | | | | | | | | |
| 10th | −7.482E−01 | −5.169E−01 | −7.538E−02 | −1.577E−02 | −5.318E−03 | −3.828E−03 | −4.310E−03 | 1.030E−03 |
| Coefficient D | | | | | | | | |
| 12th | 7.543E−01 | 4.991E−01 | 5.152E−02 | 6.055E−03 | 1.838E−03 | 1.247E−03 | 1.508E−03 | −1.538E−04 |
| Coefficient E | | | | | | | | |
| 14th | −5.550E−01 | −3.518E−01 | −2.584E−02 | −1.557E−03 | −4.463E−04 | −2.844E−04 | −3.172E−04 | 1.980E−05 |
| Coefficient F | | | | | | | | |
| 16th | 3.014E−01 | 1.832E−01 | 9.634E−03 | 2.757E−04 | 7.422E−05 | 4.411E−05 | 4.430E−05 | −2.204E−06 |
| Coefficient G | | | | | | | | |
| 18th | −1.212E−01 | −7.077E−02 | −2.667E−03 | −3.373E−05 | −8.331E−06 | −4.524E−06 | −4.298E−06 | 1.992E−07 |
| Coefficient H | | | | | | | | |
| 20th | 3.584E−02 | 2.019E−02 | 5.429E−04 | 2.809E−06 | 6.187E−07 | 2.852E−07 | 2.953E−07 | −1.365E−08 |
| Coefficient J | | | | | | | | |
| 22nd | −7.680E−03 | −4.194E−03 | −7.988E−05 | −1.522E−07 | −2.913E−08 | −8.283E−09 | −1.436E−08 | 6.767E−10 |
| Coefficient L | | | | | | | | |
| 24th | 1.158E−03 | 6.164E−04 | 8.234E−06 | 4.851E−09 | 7.884E−10 | −1.787E−10 | 4.843E−10 | −2.324E−11 |
| Coefficient M | | | | | | | | |
| 26th | −1.165E−04 | −6.073E−05 | −5.626E−07 | −6.901E−11 | −9.346E−12 | 2.451E−11 | −1.078E−11 | 5.222E−13 |
| Coefficient N | | | | | | | | |
| 28th | 7.026E−06 | 3.599E−06 | 2.284E−08 | 0 | 0 | −8.225E−13 | 1.425E−13 | −6.884E−15 |
| Coefficient O | | | | | | | | |
| 30th | −1.927E−07 | −9.696E−08 | −4.162E−10 | 0 | 0 | 1.004E−14 | −8.477E−16 | 4.031E−17 |
| Coefficient P | | | | | | | | |

Furthermore, the example optical imaging system configured described as above may have aberration characteristics as illustrated in FIG. 6.

TABLE 7

| | 1^{st} | 2^{nd} | 3^{rd} |
|---|---|---|---|
| | Embodiment | Embodiment | Embodiment |
| Fno | 1.522 | 1.535 | 1.561 |
| TTL | 7.767 | 7.808 | 7.880 |
| IMG HT | 6.329 | 6.329 | 6.329 |
| FOV | 89.12 | 88.25 | 87.358 |
| f | 6.114 | 6.262 | 6.357 |
| f1 | 6.340 | 6.344 | 6.346 |
| f2 | −14.666 | −15.917 | −16.231 |
| f3 | 763.536 | −293.262 | −336.893 |
| f4 | 21.246 | 19.984 | 20.554 |
| f5 | −54.932 | −33.597 | −31.945 |
| f6 | 51.018 | 40.583 | 40.389 |
| f7 | 7.247 | 7.297 | 7.358 |
| f8 | −4.421 | −4.300 | −4.213 |
| f12 | 9.766 | 9.356 | 9.271 |
| f123 | 9.628 | 9.564 | 9.447 |

In Table 7, Fno is an F-number of the example optical imaging system, TTL is a distance on an optical axis from an object-side surface of the first lens to an imaging plane, IMG HT is half the diagonal length of the imaging plane, and FOV is an angle of view of the optical imaging system.

f is a total focal length of the optical imaging system, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, and f8 is a focal length of the eighth lens.

In an example optical imaging system according to the one or more embodiments, a size may be reduced while realizing high resolution.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An optical imaging system, comprising:
a first lens, a second lens, a third lens, a fourth lens, a fifth lens, a sixth lens, a seventh lens, and an eighth lens, sequentially arranged from an object side toward an imaging plane,
wherein the first lens has positive refractive power, and the second lens has negative refractive power,
wherein the second lens and the third lens each have refractive indices that are greater than 1.66, and
wherein the optical imaging system satisfies the following conditional expression:
$$TTL / ( 2 \times IMG HT ) < 0.64 ,$$
where TTL is a distance on an optical axis from an object-side surface of the first lens to the imaging plane, and IMG HT is half a diagonal length of the imaging plane.

2. The optical imaging system of claim 1, wherein each of at least three lenses among the first lens to the eighth lens, including the second lens and the third lens, have a refractive index that is greater than 1.66, and
an absolute value of a focal length of the second lens, among the at least three lenses having a refractive index greater than 1.66, is the smallest absolute value.

3. The optical imaging system of claim 1, wherein the fifth lens has a refractive index that is greater than 1.66, and
wherein the optical imaging system satisfies the following conditional expression:
$$\vert v 1 - ( v 2 + v 3 + v 5 ) \vert < 10 ,$$
where v1 is an Abbe number of the first lens, v2 is an Abbe number of the second lens, v3 is an Abbe number of the third lens, and v5 is an Abbe number of the fifth lens.

4. The optical imaging system of claim 1, wherein the following conditional expressions are satisfied:
$$25 < v 1 - v 2 < 45 ; and$$
$$25 < v 1 - v 3 < 45 ,$$
where v1 is an Abbe number of the first lens, v2 is an Abbe number of the second lens, and v3 is an Abbe number of the third lens.

5. The optical imaging system of claim 1, wherein the following conditional expression is satisfied:
$$15 < v 1 - ( v 2 + v 3 ) < 25 ,$$
where v1 is an Abbe number of the first lens, v2 is an Abbe number of the second lens, and v3 is an Abbe number of the third lens.

6. The optical imaging system of claim 1, wherein the following conditional expression is satisfied:
$$1. 3 < Fno < 1.6 ,$$
where Fno is an F-number of the optical imaging system.

7. The optical imaging system of claim 1, wherein the following conditional expression is satisfied:
$$0.9 < f 1 / f < 1.2 ,$$
where f1 is a focal length of the first lens, and f is a total focal length of the optical imaging system.

8. The optical imaging system of claim 1, wherein the following conditional expression is satisfied:
$$- 3 < f 2 / f < - 1 ,$$
where f2 is a focal length of the second lens, and f is a total focal length of the optical imaging system.

9. The optical imaging system of claim 1, wherein the following conditional expression is satisfied:
$$\vert f 3 / f \vert > 30 ,$$
where f3 is a focal length of the third lens, and f is a total focal length of the optical imaging system.

10. The optical imaging system of claim 1, wherein the following conditional expression is satisfied:
$$0.3 < \vert f 1 / f 2 \vert < 0. 6 ,$$
where f1 is a focal length of the first lens, and f2 is a focal length of the second lens.

11. The optical imaging system of claim 1, wherein the following conditional expression is satisfied:
$$\vert f 1 / f 3 \vert < 0. 05 ,$$
where f1 is a focal length of the first lens, and f3 is a focal length of the third lens.

12. The optical imaging system of claim 1, wherein the following conditional expression is satisfied:
$$\vert f 2 / f 3 \vert < 0. 08 ,$$
where f2 is a focal length of the second lens, and f3 is a focal length of the third lens.

13. The optical imaging system of claim 1, wherein the following conditional expression is satisfied:
$$1. 3 < f 12 / f < 1.7 ,$$
where f12 is a composite focal length of the first lens and the second lens, and f is an overall focal length of the optical imaging system.

14. The optical imaging system of claim 13, wherein the following conditional expression is satisfied:
$$1. 3 < f 123 / f < 1.7 ,$$
where f123 is a composite focal length of the first lens to the third lens.

15. The optical imaging system of claim 1, wherein the fourth lens has positive refractive power, and the fifth lens has negative refractive power.

16. The optical imaging system of claim 1, wherein the sixth lens has positive refractive power, the seventh lens has positive refractive power, and the eighth lens has negative refractive power.
